(19) United States
(12) Patent Application Publication
(10) Pub. No.: US 2011/0185581 A1
(43) Pub. Date: Aug. 4, 2011

(54) COMPACT CIRCULAR SAW

(75) Inventors: Li Xing, Nanjing (CN); Yibao Zhang, Nanjing (CN); Feng Zhang, Nanjing (CN)

(73) Assignee: Chervon Limited, Wanchai (HK)

(21) Appl. No.: 12/835,393

(22) Filed: Jul. 13, 2010

(30) Foreign Application Priority Data
Jan. 29, 2010 (CN) 201020104874.9

(51) Int. Cl. B23D 45/16; B25F 5/02

(52) U.S. Cl. 30/374; 30/390

(57) ABSTRACT

A circular saw includes a housing, a motor having a rotating axis and a center of gravity on the rotating axis, a handle, a circular blade, a fixed guard, and a base plate having a width supporting the housing. The motor and the circular blade are parallel or coplanar with respect to each other and the circular saw does not extend beyond the width of the base plate in the width direction.

### RELATED APPLICATION

This application claims the benefit of CN 201020104874.9 filed on Jan. 29, 2010 which application is incorporated herein by reference in its entirety.

### BACKGROUND

This disclosure generally relates to circular saws and, more particularly, relates to a compact circular saw.

Traditionally, a portable circular saw comprises a housing, a motor mounted in the housing, a handle mounted on the housing, a rotatable circular blade connected with the motor, a fixed guard mounted on the housing and covering an upper part of the blade, a base plate for supporting the housing thereon, and a movable guard pivotally mounted to the housing and covering a lower part of the blade which extends out of the base plate. The motor is usually arranged perpendicular to the circular blade and located on one side of a plane in which is located the circular blade and, as such, the mass of the circular saw is not distributed evenly thereby damaging the balance of the whole machine. As a result of this arrangement, a user must continually adjust the strength and direction of the force applied to the handle during a cutting operation to maintain a cutting line in the initial plane of the blade, which thereby increases the difficulty of operating such a machine. Moreover, when the motor is arranged at one side of the circular blade in this manner, the whole machine is heavy and incompact for the user owing to size of whole machine being large in the direction of the width of the base plate.

### SUMMARY

The following disclosure is directed to a compact circular saw that includes a housing, a motor disposed in the housing and having a rotating axis and a gravity center on the rotating axis, a handle, a circular blade driven to rotate by the motor and having a diameter D, a fixed guard covering an upper part of the circular blade, and a base plate supporting the housing and having a width. The motor and the circular blade are parallel to or coplanar with each other and the circular saw does not extend beyond a range of the width of the base plate in a lateral direction.

As will become apparent from the description that follows, by arranging the motor to be parallel or coplanar to the circular blade and by restricting the circular saw within the range of the width of the base plate, the lateral width of the whole circular saw is decreased so that the circular saw is more compact. Moreover, a good gravity distribution is achieved by laterally restricting the circular saw within the range of the width of the base plate. The balance of the whole circular saw and the operability during cutting is thus greatly improved. For example, when the circular saw so constructed is placed in a position of a maximum cutting depth, the gravity of the motor is placed within a range from the base plate to a D/2 distance above the base plate and the balance of the whole circular saw becomes better with the aid of the motor having a lower center of gravity making the machine easier for a user to hold during the cutting procedure.

### BRIEF DESCRIPTION OF THE DRAWINGS

The subject compact circular saw will be further explained in detail with reference to the accompanying drawings wherein:

FIG. 1 is a perspective view of an exemplary embodiment of a circular saw constructed according to the description that follows;

FIG. 2 is a front view of the circular saw of FIG. 1;

FIG. 3 is a perspective view of the circular saw of FIG. 1 as observed from an opposite side of the motor;

FIG. 4 is a rear view of the circular saw of FIG. 1;

FIG. 5 is a top view of the circular saw of FIG. 1;

FIG. 6 is a view showing the inner structure of the circular saw of FIG. 1, wherein a half of a housing and a handle are removed;

FIG. 7 is a schematic exploded view of the circular saw of FIG. 1;

FIG. 8 is a schematic view of exemplary transmission parts of the circular saw of FIG. 1;

FIG. 9 is a front view of the circular saw of FIG. 1, wherein a half of a guard is removed;

FIG. 10 is a perspective view of the circular saw of FIG. 1, wherein a half of the guard is removed;

FIG. 11 is an exploded view of an exemplary quick lock mechanism for depth adjustment of the circular saw of FIG. 1;

FIGS. 12A-12B are schematic views of the quick lock mechanism for depth adjustment of the circular saw of another embodiment;

FIGS. 13A-13C are schematic views of the quick lock mechanism for depth adjustment being applied to fix an auxiliary base plate;

FIGS. 14A-14B are schematic views of the quick lock mechanism for depth adjustment being applied to fix an inclined cutting angle; and

FIGS. 15A-15C are schematic views of the quick lock mechanism for depth adjustment being applied to fix an additional spanner.

### DETAIL DESCRIPTION

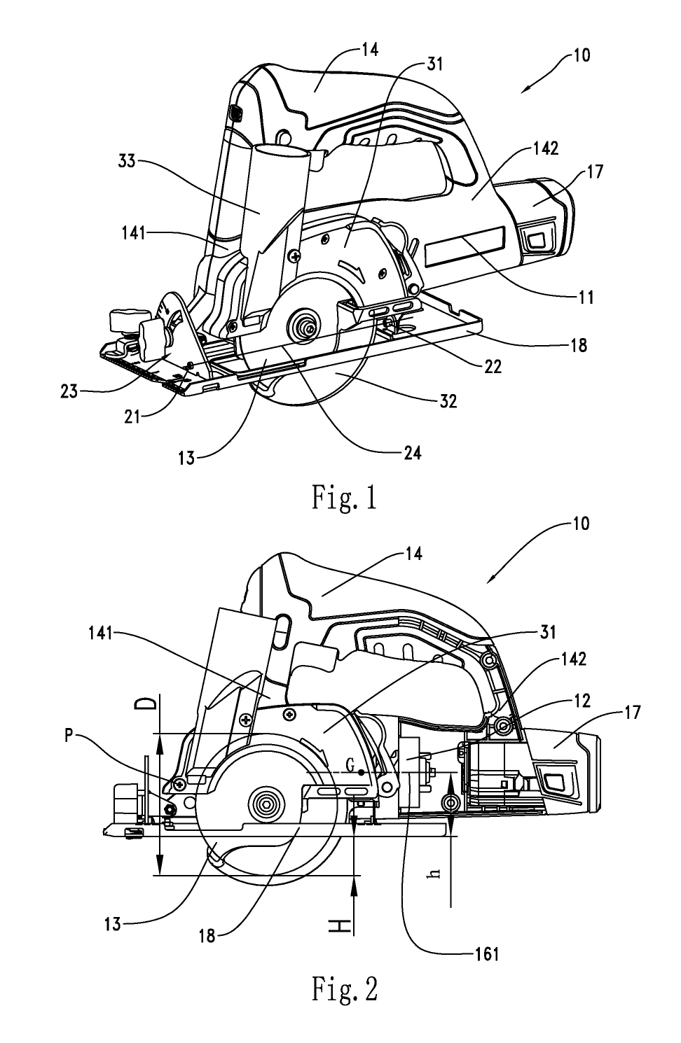

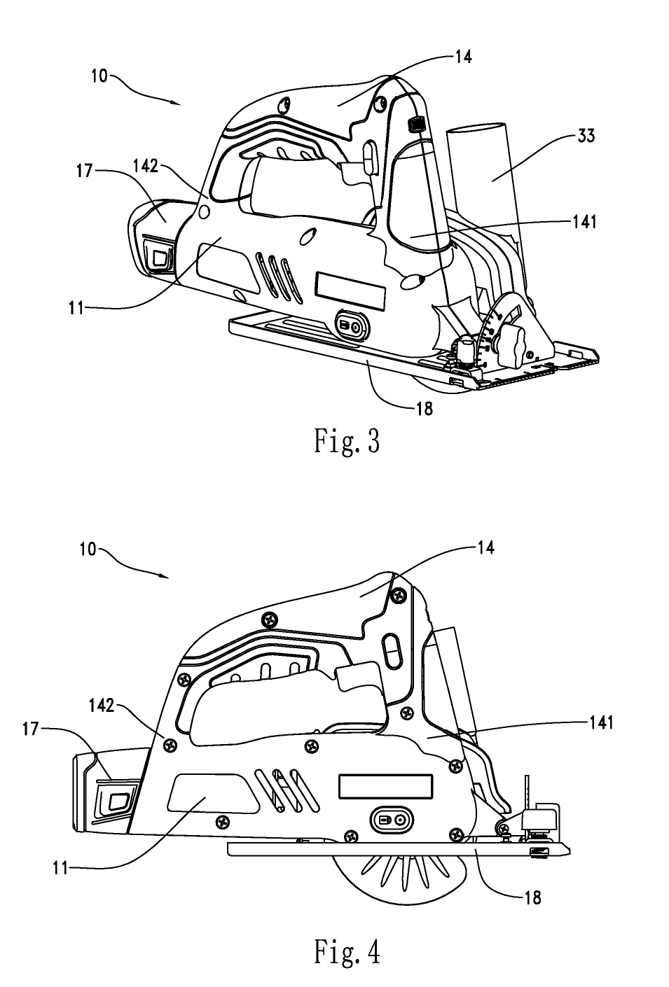

FIGS. 1-5 illustrate a circular saw 10 of a preferred embodiment constructed according to the disclosure that follows. The circular saw 10 comprises a housing 11, a motor 12 mounted in the housing 11, a circular blade 13 having a diameter D that is driven to rotate by the motor 12, and a handle 14 mounted on the housing 11. The circular saw is a small-sized, compact portable tool, for which a blade of small diameter less than 100 mm is usually used.

The circular saw 10 further comprises a power supply device for supplying power to the motor 12. In a preferred embodiment, a battery pack 17 is used to supply power to the motor 12 and is mounted behind the motor 12 so as to have a linear relationship with the motor 12. In other embodiments, the motor could be supplied with AC power by a power cord. Additionally, the connection between the battery pack 17 and the housing 11 could be of the inserting type or the sliding type. For the connecting manner of the inserting type, a projection is formed on the battery pack 17 and the housing 11 has an orifice that is correspondingly mateable with the projection so that a user can removably mount the battery pack 17 on the housing 11 by inserting the projection into the orifice of the housing 11. The connecting manner of the sliding type is commonly arranged with rails being provided on one of the battery pack 17 and the housing 11 and with grooves being arranged on the other one of the battery pack 17 and the housing 11 to receive the rails so that the user can removably connect the battery pack 17 to the housing 11 by the cooperation between the rails and grooves. Because these types of connections between the battery pack 17 and the housing 11 are well known to persons skilled in the art, the exact details of these types of connections have not been explained further for the sake of brevity.

A fixed upper guard 31 is mounted on the housing 11 of the circular saw 10 for covering an upper part of the circular blade and a moveable lower guard 32 is mounted on the housing 11 for covering a lower part of the circular blade. While the fixed upper guard 31 is illustrated as a separate component fixedly mounted on the housing 11, it can be easily understood that in other embodiments the fixed upper guard also could be formed on the housing 11 directly so as to be integrated therewith. A dust exhaust device 33 is formed on a front end of the fixed upper guard 31 for collecting the dust produced during the cutting procedure.

The circular saw 10 further comprises a base plate 18 which supports the housing 11 thereon. As best shown in FIG. 5, the base plate 18 has a width W. Preferably, the base plate 18 supports the housing 11 in such a manner that the housing 11 could be inclined relative to the base plate 18. With pivotal pins 21, 22 and an angle adjusting and locking mechanism 23, the base plate 18 could be inclined about a longitudinal axis 24 passing through the centers of the pivotal pins 21, 22. In this manner, the cutting angle of the saw blade could be correspondingly altered and the locking mechanism 23 could be used to lock the base plate 18 at a certain inclined angle. Because this type of structure for adjusting the inclined cutting angle has been widely applied to prior circular saws it need not be further explained herein.

In the illustrated, exemplary embodiment, the handle 14 is connected to the housing 11 and located above the fixed upper guard 31. The handle 14 comprises a first end 141 which is adjacent to the fixed upper guard 31 and a second end 142 which is adjacent to the battery pack 17. The first end and the second end are substantially aligned at the same height. The motor 12 is located under the handle 14 and between the first end 141 and the second end 142. For achieving a mini-sized circular saw with compact structure and better balance, the motor 12, the battery pack 17 and the handle 14 are located so as to be aligned in one plane and parallel to the plane in which the circular blade 13 lies, hereafter referred to as the plane of the blade. The distance between these two parallel planes is limited to a certain range. In the exemplary embodiment, the distance between the two planes is limited in the range of, i.e., to be less than, the width W of the base plate. All of the housing and the guards of the circular saw as well as the motor and the saw blade disposed therein do not extend beyond the range defined by the width W of the base plate. By arranging the motor 12 parallel to the circular blade 13, and restricting the housing and the guard of the circular saw within the range of the width W of the base plate, the width of the whole circular saw in the lateral direction is decreased, so that the structures of the circular saw is more compact. Also, during a linear cutting, two sides 181, 182 of the base plate 18 could both be used for the function of orientation. Moreover, the motor 12 is arranged parallel relative to the plane of the blade at its one side, and it is limited in a defined range from the plane of the saw blade, so that a good gravity or mass distribution could be achieved whereby the balance of the whole circular saw and the operability during the cutting procedure are greatly improved. In other embodiments, for achieving better results in compaction and balance, the motor 12 could also be arranged to be coplanar with the plane of the blade, that is, the rotation axis of the motor lies in the plane of the blade.

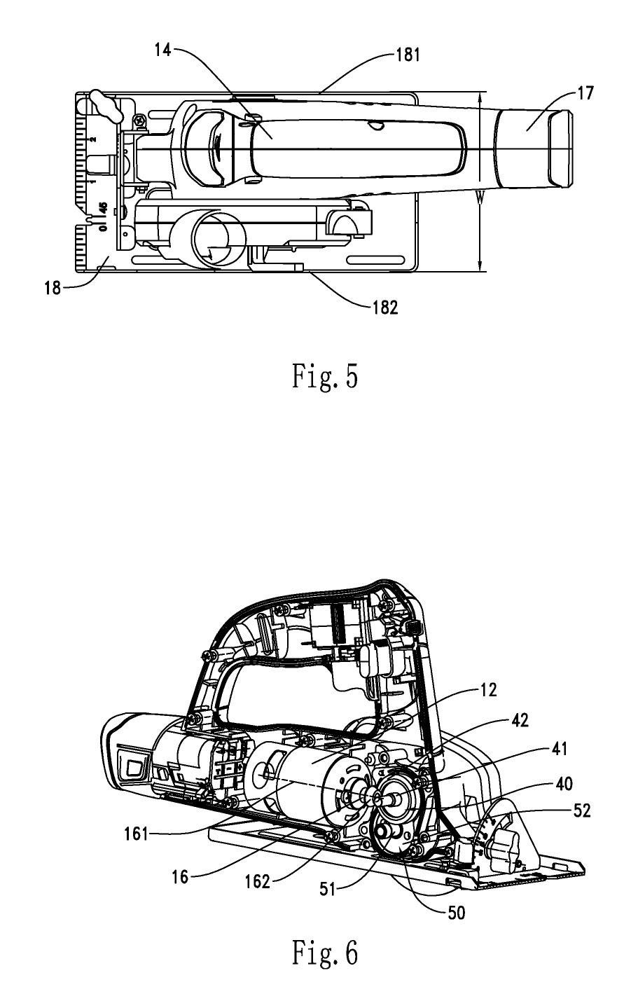

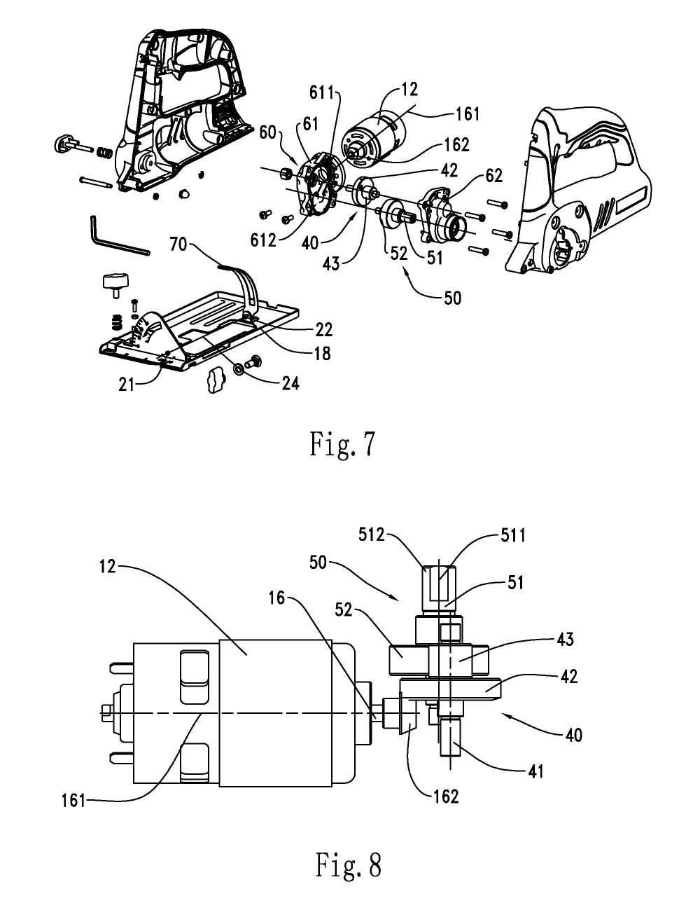

Now referring to FIGS. 6-8, the rotation movements of the motor 12 are transmitted to the circular blade 13 by a primary bevel gear transmission and a primary gear transmission, which can ensure that the circular saw 10 could reach a deepest cutting depth among the blades of the same specifications while achieving deceleration. The motor 12 comprises a motor driving spindle 16 which could be rotated about the rotation axis 161 of the driving spindle 16. A motor bevel gear 162 is arranged on the driving spindle 16. An intermediate gear set 40 comprises a large bevel gear 42 and a small gear 43 which are arranged on a common gear axis 41. The large bevel gear 42 of the intermediate gear set 40 is engaged with the bevel gear 162 of the motor to form a stage of a bevel gear transmission. The gear axis 41 is perpendicular to the axis of the driving spindle 16 of the motor. An output spindle assembly 50 comprises an output spindle 51 that is parallel to the gear axis 41 having a large gear 52 located thereon. The large gear 52 is engaged with the small gear 43 of the intermediate gear set 40 to form a stage of the gear transmission. The end 512 of the output spindle 51 which is farthest from the intermediate gear set 40 is used for installing and supporting the circular blade 13. The circular blade 13 would thus be rotated about the axis line 511 of the output spindle 51. A worm gear and worm transmission mechanism combined with a single or several stages of gear or belt transmission mechanisms could be used to replace the above described structure. The circular saw 10 of the invention could also be used to implement a larger cutting depth by the transmission mechanism. As shown in FIG. 2, at the position of the maximum cutting depth, the range of the deepest cutting depth H is between D/4 and D/3, wherein D is the diameter of the circular blade 13.

The circular saw 10 further comprises a gear box 60 which could receive the above-mentioned motor bevel gear 162, intermediate gears 40 and output spindle assembly 50. The gear box 60 is composed of a gear box body 61 and a gear box cover 62. The gear box body 61 comprises a first opening end 611 for receiving the motor bevel gear 162 and a second opening end 612 for receiving the intermediate gear set 40 and the output spindle assembly 50, and the second opening end 612 is substantially perpendicular to the first opening end 611. The gear box cover 62 is fixedly connected to the second opening end 612 of the gear box body 61 by bolts 63, so that the transmission mechanism is fixed and supported in the gear box 60. The gear box body 61 and the gear box cover 62 are made of plastic materials and directly formed by using an injection process. A support bearing (not shown in the figures) is embedded in the gear box 60 also by use of an injection process. Compared with the traditional gear boxes made of aluminum, the gear box of the invention is made of plastic, which reduces the weight of the whole set while realizing support for and fixation of the gear transmission mechanism, so that the operability of the whole circular saw is raised. Moreover, via use of an injection molding process the difficulty of manufacture is decreased.

Referring again to FIGS. 1-5, the motor 12 has a lower center of gravity G which is located on the rotation axis line 161 of the motor and close to the base plate. When the circular saw is located at the position of a maximum cutting depth (the position shown in FIG. 2), the center of gravity G of the motor is located within the range from the base plate to the D/2 distance above the base plate with the inclined angle between the rotation axis 161 of the motor 12 and the base plate 18 being set to less than 15 degree. Preferably, the rotation axis 161 is parallel to the base plate 18, that is, the inclined angle between these two is zero degrees. That the motor 12 has the lower center of gravity and the handle 14 is located above the fixed upper guard 31 makes the balance of the whole set better, thereby making the device easier to hold. Moreover, the lower center of gravity would reduce any trend that the center of gravity of the motor is away from the cutting position when the circular saw is tilted and overturned, so that the balance of the circular saw would be further improved and the circular blade would not be deviated easily during the procedure of cutting, with the result of cutting precision being improved.

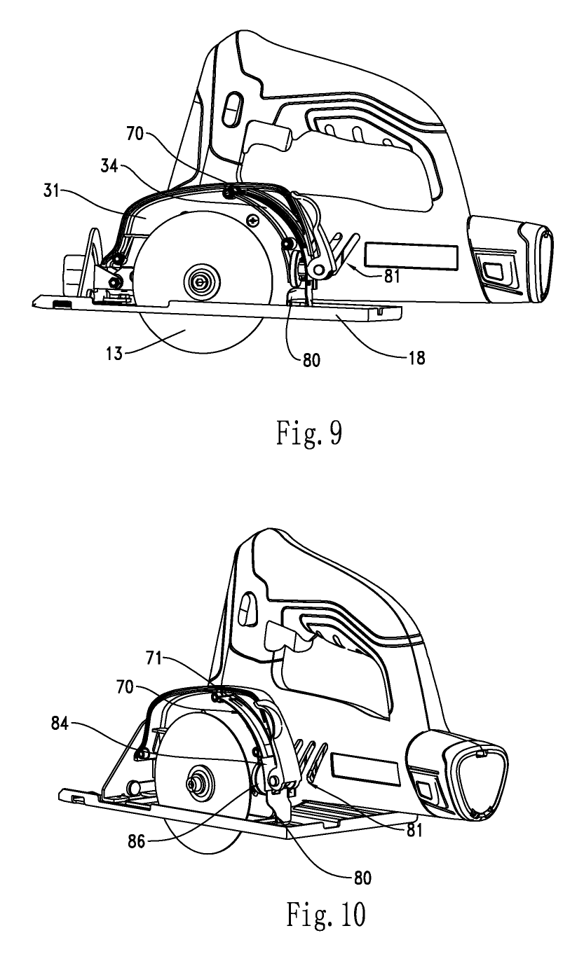

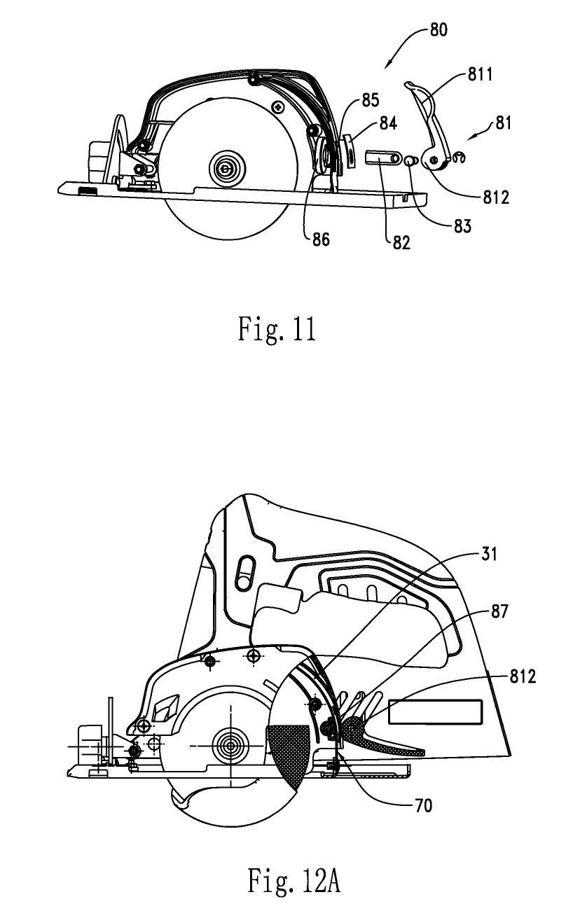

Furthermore, the housing 11 is supported by the base plate 18 in a known manner, so that the housing 11 could pivot about the pin P so as to change the cutting depth of the circular blade. Referring to FIGS. 9-11, the circular saw 10 further provides a depth adjusting bracket 70 and a depth locking mechanism 80 for setting the distance that the circular blade 13 extends below the base plate 18 and for fixing the circular blade 13 at the position of a certain cutting depth. One end of the depth adjusting bracket 70 is connected to the rear end of the base plate 18 by the pin 22 (as shown in FIG. 1) which is inclined about the longitudinal axis 24 relative to the base plate 18 together with the housing 11. The depth adjusting bracket 70 extends from the base plate 18 up into the fixed upper guard 31. The fixed upper guard 31 comprises a groove 34 for receiving the depth adjusting bracket 70 therein so as to separate the depth adjusting bracket 70 from the circular blade 13. The depth adjusting bracket 70 has substantially the same curvature as the fixed upper guard 31 and the groove 34 so that the depth adjusting bracket 70 would not be hindered by the fixed upper guard 31 and groove 34 when the depth adjusting bracket 70 and the base plate 18 are pivoted together up and down. An elongated slot 71 is formed on substantially the whole length of the depth adjusting bracket 70. The depth locking mechanism 80 is used for fixing a base plate 18 in a desired cutting depth position relative to the circular blade 13. The depth locking mechanism 80 comprises a locking handle 81 and a locking lever 82, wherein the locking handle 81 is fixedly connected to the locking lever 82 by a pin 83. The locking lever 82 passes through a spacer 84, a hole 85 of the fixed upper guard and the slot 71 of the depth adjusting bracket 70 and is connected to a nut 86. The nut 86 is connected to the locking lever 82 by threads and is located in the fixed upper guard 31. One end 811 of the locking handle 81 is used for operation by the user, and the other end is formed with a cam 812. Rotating the end 811 of the locking handle 81 will make the surface of the cam 812 having a larger radius contact with the spacer 84 so that the depth adjusting bracket 70 is pressed firmly between the fixed upper guard 31 and the cam 812 achieving the function of quick locking. Moreover, the nut 86 is mounted on the locking lever 82 by threads. The quick locking mechanism for depth could be adjusted to a suitable locking degree by turning nut 86. Turning the nut 86 in the direction close to the locking handle 81 causes the distance between the locking handle 81 and the depth adjusting bracket 70 to become shorter and the degree that the cam 812 is pressed to the depth adjusting bracket 70 becomes tighter. Turning the nut 86 in the direction away from the locking handle 81 causes the distance between the locking handle 81 and the depth adjusting bracket 70 to become longer and the degree that the cam 812 is pressed to the depth adjusting bracket 70 becomes looser. The quick locking could be achieved by this kind of depth locking mechanism 80 with the locking handle. The tightness could be adjusted by the nut 86. When the tightness of the depth locking mechanism 80 becomes loose after being used for a long time, it could be adjusted to be suitable degree again by turning the nut 86. Compared with the traditional manner of tightening by a bolt, the cam-type locking mechanism with locking handle is operated more conveniently and comfortably.

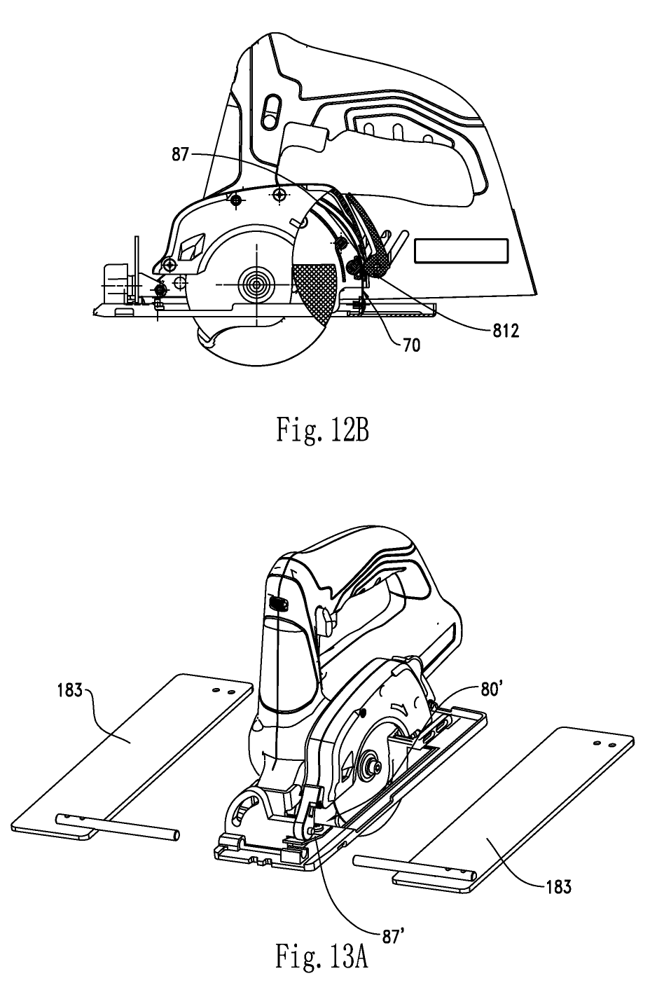

Referring to FIGS. 12A-12B, the above-mentioned nut 86 could be omitted. The function of anti-loosing could be achieved by an elastic piece 87 arranged between the cam 812 and the depth adjusting bracket 70. The elastic piece 87 is fixed on the fixed upper guard 31. In FIG. 12, the locking mechanism is in the loose state, and the elastic piece 87 is separated away from the depth adjusting bracket 70. In FIG. 12B, the depth locking mechanism 80 is in the tight state, and the elastic piece 87 contacts with the depth adjusting bracket 70. The depth adjusting bracket 70 is pressed firmly on the fixed upper guard 31 under the function of the cam 812.

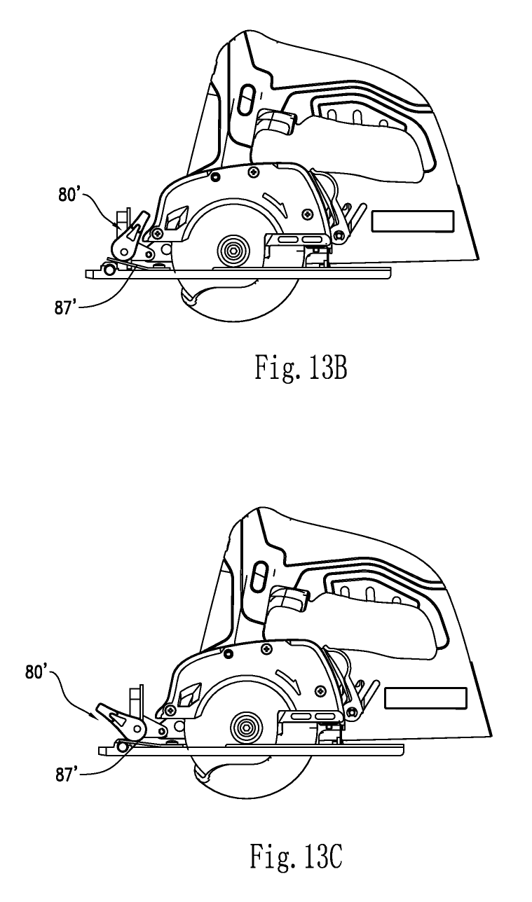

Referring to FIGS. 13A-13C, an auxiliary base plate 183 could be attached on the two sides of the base plate 18 as needed to assist in a cutting procedure. The auxiliary base plate 183 is fixed on the base plate 18 by a cam-type locking mechanism 80′ which is structured similar to above-mentioned locking mechanism 80 with a locking handle and an elastic piece for anti-loosing 87′ being provided between the cam and the base plate.

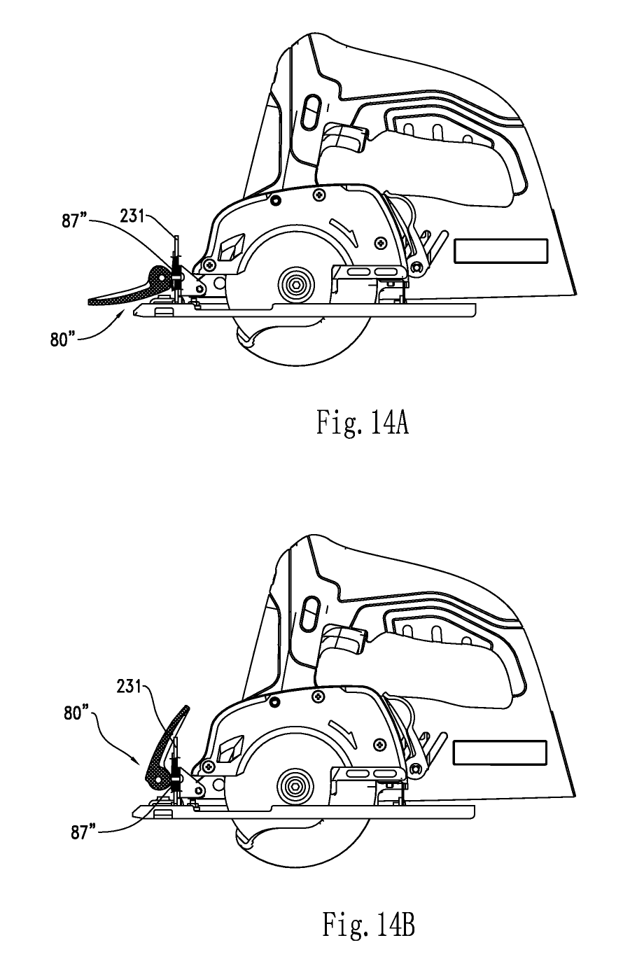

Also, a cam-type locking mechanism 80″ with a locking handle could be provided for locking the inclined cutting angle position. Referring to FIGS. 14A-14B, an elastic piece for anti-loosing 87″ is provided between the cam and the angle adjusting bracket 231.

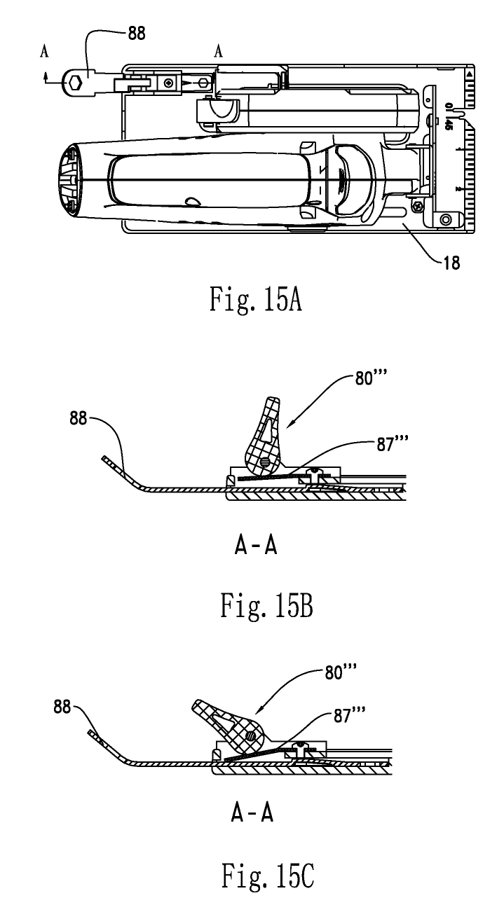

Referring to FIGS. 15A-15C, a cam-type locking mechanism 80′″ and an elastic piece for anti-loosing 87′″ are applied to fix the additional spanner 88 on the base plate 18.

The above mentioned embodiments are only explanatory to the concept and principle of this invention and are but not intended to limit the protection range of the invention. Those skilled in the art will contemplate that the invention will have a lot of other modifications or variations without departing from the spirit and concept of the invention. The protection range of this invention will therefore be determined by the claims that follow.

What is claimed is:

1. A circular saw comprising:
a housing;
a motor disposed in the housing driving a shaft about a rotating axis, the motor having a center of gravity on the rotating axis;
a handle associated with the housing;
a circular blade carried by the housing driven to rotate by the motor shaft and having a diameter D;
a fixed guard associated with the housing covering an upper part of the circular blade; and
a base plate supporting the housing and having a width;
wherein the motor and the circular blade are positioned parallel with respect to each other.

2. The circular saw of claim 1, wherein the handle is located above the fixed guard.

3. The circular saw of claim 1, wherein the circular saw further comprises a battery pack for supplying power to the motor.

4. The circular saw of claim 3, wherein the battery pack is mounted behind the motor and is aligned linearly with the motor.

5. The circular saw of claim 1, wherein the diameter D of the circular blade is no more than 100 mm.

6. The circular saw of claim 1, wherein the center of gravity of the motor is located in a range from the base plate to a D/2 distance above the base plate when the circular blade is located at a position of maximum cutting depth.

7. The circular saw of claim 1, wherein an inclined angle between the rotational axis of the shaft and the base plate is no more than 15 degrees when the circular blade is set at a position of maximum cutting depth.

8. The circular saw of claim 1, wherein the motor and the circular blade are connected by a multistage transmission mechanism.

9. The circular saw of claim 8, wherein a maximum cutting depth of the circular blade is between D/4 and D/3.

10. The circular saw of claim 1, wherein the circular saw does not extend beyond the base plate in the width direction.

11. A circular saw comprising:
a housing;
a motor disposed in the housing driving a shaft about a rotating axis, the motor having a center of gravity on the rotating axis;
a handle associated with the housing;
a circular blade carried by the housing driven to rotate by the motor shaft and having a diameter D;
a fixed guard associated with the housing covering an upper part of the circular blade; and
a base plate supporting the housing and having a width,
wherein the motor and the circular blade are positioned co-planarly with respect to each other.

12. The circular saw of claim 11, wherein the handle is located above the fixed guard.

13. The circular saw of claim 11, wherein the circular saw further comprises a battery pack for supplying power to the motor.

14. The circular saw of claim 13, wherein the battery pack is mounted behind the motor and is aligned linearly with the motor.

15. The circular saw of claim 11, wherein the diameter D of the circular blade is no more than 100 mm.

16. The circular saw of claim 1, wherein the center of gravity of the motor is located in a range from the base plate to a D/2 distance above the base plate when the circular blade is located at a position of maximum cutting depth.

17. The circular saw of claim 11, wherein an inclined angle between the rotational axis of the shaft and the base plate is no more than 15 degrees when the circular blade is set at a position of maximum cutting depth.

18. The circular saw of claim 11, wherein the motor and the circular blade are connected by a multistage transmission mechanism.

19. The circular saw of claim 18, wherein a maximum cutting depth of the circular blade is between D/4 and D/3.

20. The circular saw of claim 11, wherein the circular saw does not extend beyond the base plate in the width direction.
